(19) United States
(12) Patent Application Publication
(10) Pub. No.: US 2023/0128000 A1
(43) Pub. Date: Apr. 27, 2023

(54) PRIVATE EXCHANGE FOR ELECTRONIC SPORTS BETTING

(71) Applicant: EBET, Inc., Las Vegas, NV (US)

(72) Inventors: Stephan Roberts, Jackson, MS (US); Jason Finch, Jackson, MS (US); Bradley Cole, Las Vegas, NV (US)

(21) Appl. No.: 17/972,528

(22) Filed: Oct. 24, 2022

Related U.S. Application Data
(60) Provisional application No. 63/271,063, filed on Oct. 22, 2021.

(51) Int. Cl. G07F 17/32

(52) U.S. Cl. CPC G07F 17/3288; G07F 17/323

(57) ABSTRACT

A system and method for establishing a private exchange for electronic sports events includes establishing consolidated odds for one or more electronic sports events, each electronic sports event including a multi-player video game, the consolidated odds being established based on a history of each player in the multi-player video game. A method includes subscribing one or more bettors on each electronic sports event to a private betting exchange established for each of the one or more electronic sports event, and receiving a books offer to lay each private betting exchange based on the consolidated odds established for each of the one or more electronic sports event. A method includes opening a matching period to match bets submitted by each subscribed bettor for selected ones of the of one or more electronic sports events, and matching the bets based on the consolidated odds.

### CROSS-REFERENCES TO RELATED APPLICATIONS

The present application claims priority of U.S. Provisional Application No. 63/271,063, filed Oct. 22, 2021, and entitled “PRIVATE EXCHANGE FOR ELECTRONIC SPORTS BETTING”, the entirety of which is incorporated by reference herein.

### TECHNICAL FIELD

The subject matter described herein relates to betting platforms, and more particularly to a private exchange for electronic sports (“esports”) betting.

### BACKGROUND

A betting exchange is a marketplace for bettors to bet on the outcome of events, such as a sporting event or game. They allow bettors to wager against each other for low fees. Betting exchanges are a great concept when they work, but often provide a poor experience outside of a few popular sports or games like football or soccer. Further, they can take many years to establish really tight markets. Getting the full experience of exchange betting also requires the use of a third-party betting/trading application (“app”) and learning a new way of betting. The best markets on some exchanges can be 101% overround, however, if betting size, the actual odds available are usually significantly and non-transparently different. Without a third-party app, it is often impossible to know exactly what odds one can get for a large bet.

Placing large open bets on a betting exchange can be complicated at best, and dangerous at worst. Making markets on a betting exchange requires sophisticated software and risk management. Several of the biggest differences between making a market on a betting exchange versus a book are that there are no protections from bad bets, no ability to void bets, close accounts or suspend markets. Managing and preventing errors is a large part of market making. Speed is also a major factor both for market makers and automated bettors trying to pick off the best odds.

The widely perceived advantage of private exchanges, or “dark pools,” in financial markets is that they are “hidden” from the public exchanges, and so the public exchange markets do not react to large orders resulting in unfavorable prices. For example, placing a very large order to buy stock on a public exchange will inevitably lead to the prices moving up because everyone sees there is a big buyer. As a result, the buyer will have to pay a higher price to fill their order. A less well known but more important feature of dark pools is that they are required to execute trades at prices set by the public markets. A buy order placed on a dark pool cannot trade higher than the lowest price available on a public exchange (there are additional protections to prevent traders manipulating public prices based on visible orders on dark pools).

There are multiple betting exchanges currently in operation, but mostly in the highly liquid sports like football, soccer, and horse racing. It is difficult to bet in large sizes without impacting market prices, and for most markets it involves a significant effort managing multiple smaller bets to hide your activity. Less liquid markets do not see enough volume to facilitate large bets and the odds are generally not competitive enough to justify using an exchange versus a regular book. The product development costs for a standard or white label exchange are very high.

Vigorish, or “vig,” is a fee charged by a bookmaker for accepting a bettor's wager. In American English, it can also refer to the interest owed to an illegal loaner such as a loan shark in consideration for credit.

Electronic sports (“esports”) is a form of event using video games, typically of the multiplayer variety. Esports are quickly gaining in popularity and have established their own betting market. However, given their high costs and long time to develop, there are currently no viable betting exchanges for esports.

### SUMMARY

This document describes a system and method for executing a private exchange for esports betting. The system and method implement proprietary models configured to offer low vig, and high returns across all esports games.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein.

Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an esports betting platform, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a system block diagram of a private exchange for electronic sports betting, consistent with the subject matter described herein;

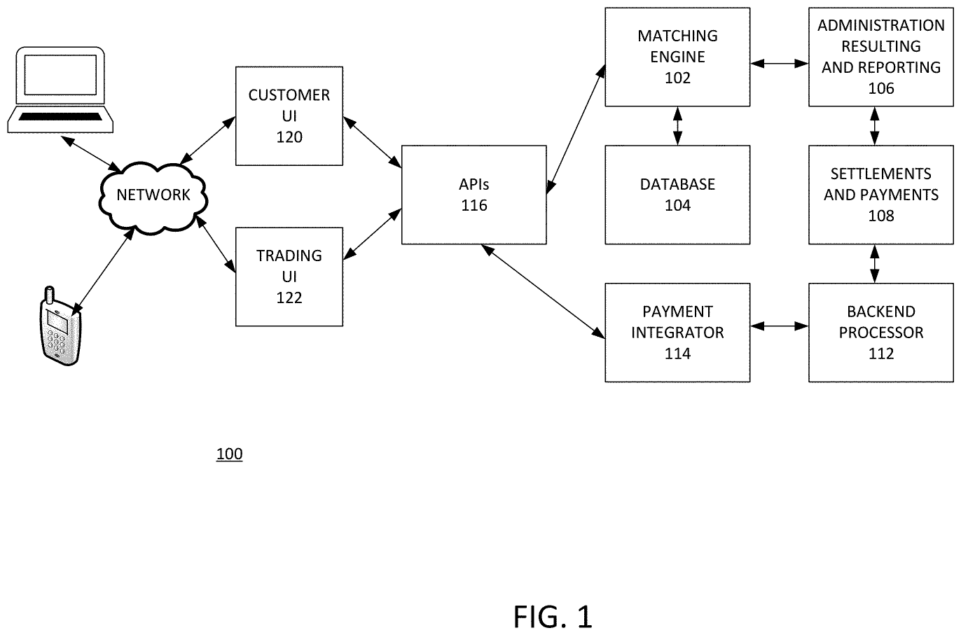

FIG. 2 shows several UIs of a system, having one or more features consistent with implementations of the current subject matter; and

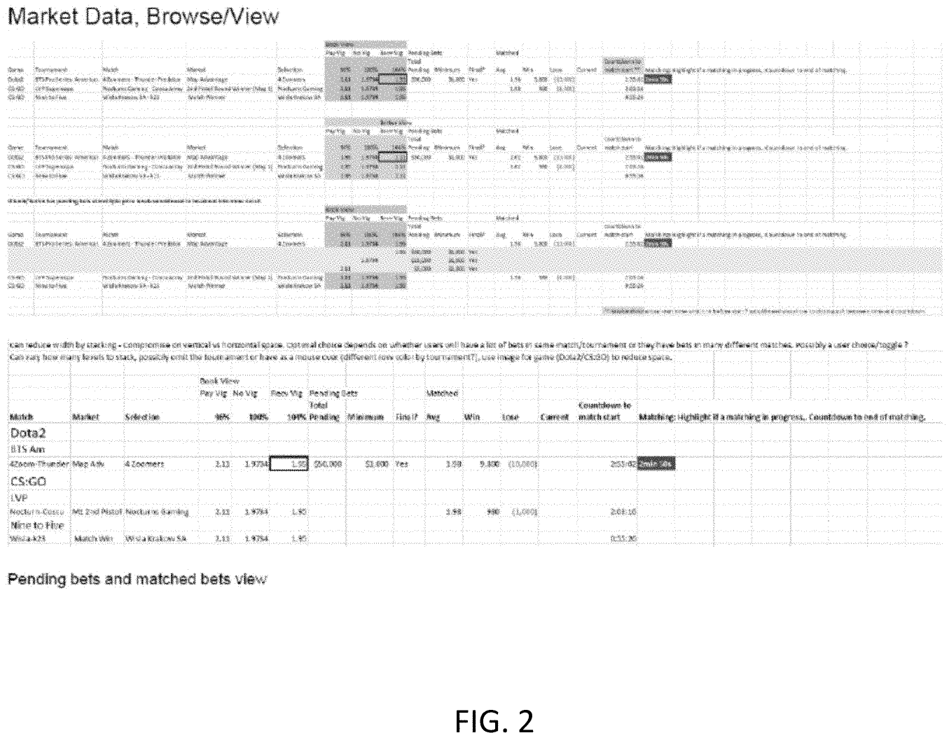

FIG. 3 is a flowchart of a method of providing a betting exchange, in accordance with the description herein.

When practical, similar reference numbers denote similar structures, features, or elements.

### DETAILED DESCRIPTION

This document describes a system and method for executing a private exchange for esports betting. In some implementations, a system 100 includes a number of subsystems, including a matching engine 102, a database 104, and associated backend infrastructure, such as an administration, resulting and reporting system 106, and a settlement and payments system 108 having a user interface (UI) 110, backend processor 112 and payment integrator 114. The system further includes one or more application program interfaces (API) 116 for connecting the subsystems together, and for interfacing a customer UI 120 for each customer, and a trading UI 122 for risk-taking as provider or taker.

The system and method implement proprietary models configured to offer low vig and high returns across all esports games. The system and method implement several approaches to executing transactions on financial dark pools. In some implementations, the system and method described herein differs from other betting exchanges in how to protect LQ providers. Given the lack of regulation in betting exchanges in general, and the need to attract customers (specifically LQ providers), providing protections for LQ providers is vital. These protections also make it easier to attract full time market makers as the pool grows.

The system and method provide real-time continuous matching, preferably using a traditional exchange model, as well as real-time continuous matching with hidden or indicative orders. This is similar to a traditional exchange, but with additional protections for participants. For example, a system and method may use the concept of a “firm up” where a counterparty responds to an indicative order to firm up the details. The system and method also provide mid-price execution, which offers price improvement for both parties, based on NBBO (BGO).

In some implementations, the system and method provide a mini auction, in which orders are executed every n seconds or minutes using a standard uncrossing algorithm. This protects against participants with a speed advantage, and the length of n can be randomized to provide more protection against speed advantages, which works in highly liquid markets.

The system and method can also implement an LQ provider/taker mechanism, where participants are categorized as providers or takers. In such an implementation, LQ providers (e.g., books) advertise a position, and takers choose whether to take the trade/bet. The price is either specified by the LQ provider or set based on NBBO (BGO). LQ providers can set specific parameters on the order to reduce risk, e.g., minimum size, specific counterparty types, specific counterparties, or counterparties with a low adverse selection score. In yet other implementations, the system and method can include price/time priority versus price/capacity/size/time. In such implementations, certain participants (e.g., providers) are prioritized over other participants, and large sized bets are prioritized over small lots.

In some implementations, customers can have at least three options: First, offer at price A where the customer receives some vig (this is equivalent to a book offering odds). Second, offer at price B where the customer pays some vig (this is equivalent to a bettor placing a bet on a book). And third, offer at price C where neither party pays vig (this is equivalent to matching with 100% overround). If one wants to receive vig then the other party must be willing to pay vig, whereas matching at the no vig price (C) benefits both parties. In terms of marketing odds, the system and method described herein has no vig on prices.

In accordance with systems and methods described herein, customers are further categorized into “Books” and “Bettors,” as described below. Books can be treated preferentially to Bettors (more protection, better prices) and a Book designation should only be given to recognized bookmakers or independent organizations that commit to some level of market making or liquidity provision (they place multiple offers across multiple markets). This is different from a typical exchange model where all customers are treated (mostly) as equals. Bettors should still get better size and odds than from any other source, especially in markets that are matching at Fair Value Odds (No Vig). Some organizations can apply or register with the system to be both a Book and a Bettor.

Visually this can look like a regular book with markets and odds (i.e., no back/lay on each market like an exchange). The big difference versus an exchange or book are that the pool sets the odds, using our own models and a consensus of odds from multiple books, odds providers, exchanges. A Book that chooses to lay in the pool will have to lay at odds established by the system. If customers do not like the ‘pool sets the odds’ approach, odds with hidden size (similar to iceberg orders in financial markets) can be provided. Markets will have a minimum bet size but no indication of the current maximum; this opacity will prevent activity in the pool from influencing public odds (i.e., no-one can tell for sure whether $10,000 or $100,000 is available and how much is being matched).

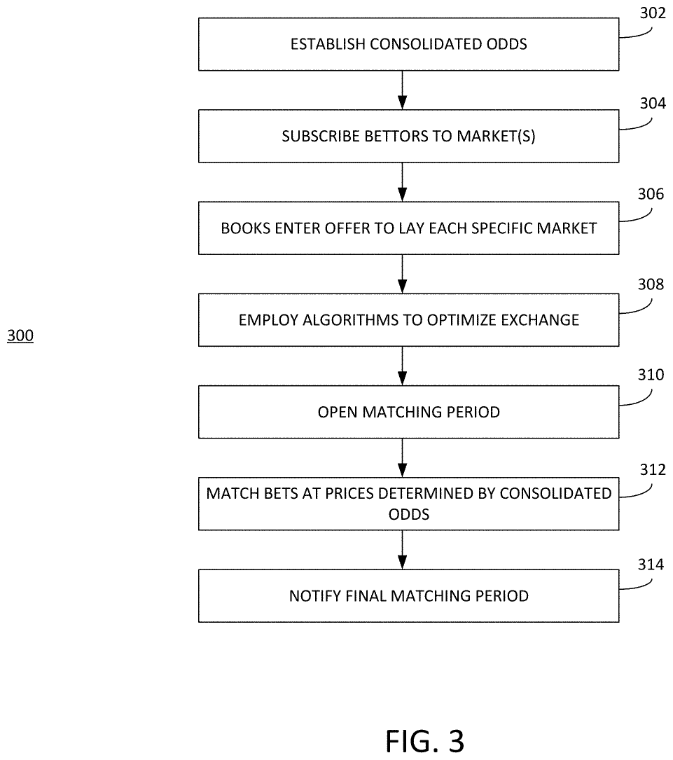

The system and method works as follows, assuming pre-game betting only but applies to live markets with a shorter matching period. FIG. 3 is a flowchart 300 of a method executed by a system. At 302, guaranteed odds are established for the market using a consolidation of available odds from multiple feed providers and books or our own models. This will give customers confidence that they will match at competitive odds. These consolidated odds should be tighter than those available at any individual book or at least as good as the best book. The method of calculation should avoid too many changes or short-term manipulation. At 304, Bettors subscribe to markets they are interested in (this could be a single market, a group of markets or all markets).

At 306, Books enter an offer to lay a specific market. At 308, a Book offer is sent to Bettors who have subscribed to that market. Bettors have a fixed time to respond (the “matching period”) to a Book offer (this eliminates any speed advantage and short-term manipulation). If multiple Bettors respond, they will be matched with the Book according to a proprietary matching algorithm (not necessarily first-come, first-served). At 308, multiple algorithms can be employed to optimize the method (e.g., price/time priority, price/size/time priority, price/size/VIP priority, price/equal distribution etc.) for each particular esports game, tournament, or event.

At 310, if no Bettors respond within the matching period, the offer will remain open. Any Bettor responding to an open offer will trigger a new matching period. In alternative implementations, other Bettors can be notified that a new matching period has started.

At 312, all bets are matched at prices determined by the consolidated odds, if a request remains open after the matching period and the consolidated odds change then any subsequent matching period will use the new odds. Books do not need to continually update their requests if the consolidated odds change. (Large or sudden moves will trigger protections). Effectively this will allow Books to make a market without the burden of modeling or updating odds. Books can specify a minimum bet size but the total amount they want to lay off is not displayed (e.g., a Book may want to lay off $50,000 but might set a minimum size of $5,000. Other customers seeing an offer to lay $50,000 may cause the consolidated odds to move either by hitting multiple books or moving their own odds).

Bet activity can be hidden from other Bettors until a bet request is filled, canceled or the market is settled, they will not know how many other Bettors are responding or how much is being matched. There can be some gaming between how high to set the minimum and how much Bettors will offer to take. If the matching algorithm prioritizes by size, then Bettors will be more likely to get a match if they respond with a larger size. Bettors taking the minimum size multiple times in a row should be discouraged as this could lead to information-gathering and odds manipulation.

At 314, X seconds/minutes before a match starts, Books and Bettors are notified of a final matching period. All open offers and any new offers are matched at the no vig (mid-price) of consolidated odds. The matching period can be extended until the game actually starts rather than use a predetermined end time (could result in a longer or shorter matching period). Success factors to track include one or more of a ratio of requested bets to matched bets, time to match, and/or volume matched per bet.

Additional/Advanced Features

In some implementations, both sides are allowed to confirm the odds before matching. In other implementations, when submitting a request, Books and Bettors can specify how aggressive they are willing to be on odds. For example, if the consolidated odds are Team A: 1.95 vs Team B: 1.90 and a Book wishes to lay risk on Team A, then they could specify whether they want to match at the consolidated book odds for Team A (lay Team A at 1.95, less likely to match), offer to match at no vig odds (lay Team A at 1.9734, both parties get a good price) or even offer to pay some vig (lay Team A at 2.0520).

In still other implementations, Bettors are allowed to offer price improvement to gain priority in matching, e.g., if the Book requests no-vig/mid-price (1.9734) and multiple Bettors respond, any Bettors who responded with book odds (1.9500) will be matched before Bettors who responded to the no-vig offer. Additionally, Books can be allowed to specify a price, as long as it is within the consolidated odds range (1.9500 to 2.0520) or if consolidated odds are suspended/unavailable. Books may prefer to set specific odds rather than accept pool odds. This would also allow a pivot to a more traditional exchange model, if needed. Books can also be allowed to specify a range of odds they will accept if book odds move. (e.g., leave the offer open if odds move +/−5% or +/−$5,000 but cancel or notify the Book if they move more than that).

In yet other implementations, Books have the option of cross-matching with the opposite outcome (e.g., for Team A versus Team B, if Book1 offers to lay Team A and Book2 offers to lay Team B, they would be matched at an appropriate no-vig/mid-price).

Each Bettor's performance can be monitored as follows: Bettors who demonstrate exceptional ability to take winning bets or take bets just before odds move in the Bettor's favor are generally bad for Books. By monitoring and scoring each Bettor, their ability to take advantage of Books can be restricted. Some options could be to place Bettors with a higher score lower in the priority order when matching or allowing Books to specify that they do not want to match with high scoring Bettors (e.g., if a Book has multiple open offers it might be preferable to not match or wait for Bettors with a lower score than to only match on offers that lose).

Books can be allowed to indicate that they do not want to match with a list of Books or Bettors (e.g., a Book may not want to match with itself if operating as both a Book and Bettor, with a list of affiliates or a specific competitor). If the odds change more than a specified amount, then open offers will be frozen, and Books will have the opportunity to cancel or adjust parameters.

Books can pre-submit offers for the final matching period only. No notifications will be sent to Bettors and the offer will be added to the final matching period once it starts. Books will be able to adjust size at any time up until the final matching period starts.

Consolidated odds can utilize proprietary analysis of accuracy and latency of each odds source to reduce market manipulation and the impact of stale data. Faster, more reliable sources can be weighted higher than others. Sources with higher bet limits can also be weighted higher. Additionally, sources for potential manipulation of the consolidated odds can be monitored, especially if they are benefiting from improved pricing (e.g., if Pinnacle were the highest weighted source and they wanted to lay off some risk, they could temporarily change their odds to impact the consolidated odds and match at better odds). Eventually, matched bet details can be sent (like time and sales) to all subscribers (such as, for example, for an extra fee). This can be sent after settlement to avoid impacting the market but can also be sent after each matching period is complete if there is enough volume and strong demand (i.e., in a premium service).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
establish consolidated odds for one or more electronic sports events, each electronic sports event including a multi-player video game, the consolidated odds being established based on a history of each player in the multi-player video game;
subscribe one or more bettors on each electronic sports event to a private betting exchange established for each of the one or more electronic sports event;
receive a books offer to lay each private betting exchange based on the consolidated odds established for each of the one or more electronic sports event;
open a matching period to match bets submitted by each subscribed bettor for selected ones of the of one or more electronic sports events; and
match the bets based on the consolidated odds.

2. The computer program product in accordance with claim 1, wherein the operations further comprise an operation to optimize each betting exchange with at least one algorithm to match the bets.

3. The computer program product in accordance with claim 1, wherein the operations further comprise an operation to prioritize the bets based on a vig amount offered with each bet.

4. The computer program product in accordance with claim 1, wherein the operations further comprise an operation to score each bettor that subscribes to the betting exchange.
